(19) United States
(12) Patent Application Publication
(10) Pub. No.: US 2025/0338237 A1
(43) Pub. Date: Oct. 30, 2025

(54) MULTIPLE TIME ALIGNMENT TIMERS

(71) Applicant: Nokia Technologies Oy, Espoo (FI)

(72) Inventors: Matha DEGHEL, Massy (FR); Keeth Saliya Jayasinghe LADDU, Espoo (FI)

(21) Appl. No.: 18/877,380

(22) PCT Filed: Jul. 13, 2023
(86) PCT No.: PCT/FI2023/050440

§ 371 Date: Dec. 20, 2024

(30) Foreign Application Priority Data
Jul. 22, 2022 (FI) 20225686

(51) Int. Cl. H04W 56/00; H04L 1/1822

(52) U.S. Cl. CPC H04W 56/0045; H04L 1/1822

(57) ABSTRACT

Disclosed is a method comprising determining, based on an expiration of at least one time alignment timer of at least two time alignment timers, whether to flush one or more hybrid automatic repeat request, HARQ, buffers.

### FIELD

The following example embodiments relate to wireless communication.

### BACKGROUND

In a wireless communication system, a user device may apply a timing advance to adjust the timing of an uplink frame in order to have alignment with a downlink frame in the time domain. However, there is a challenge in how to apply the timing advance, for example, when the user device transmits to at least two transmission and reception points simultaneously.

### BRIEF DESCRIPTION

The scope of protection sought for various example embodiments is set out by the independent claims. The example embodiments and features, if any, described in this specification that do not fall under the scope of the independent claims are to be interpreted as examples useful for understanding various embodiments.

According to an aspect, there is provided an apparatus comprising at least one processor, and at least one memory storing instructions which, when executed by the at least one processor, cause the apparatus at least to: determine, based on an expiration of at least one time alignment timer of at least two time alignment timers, whether to flush one or more hybrid automatic repeat request, HARQ, buffers.

According to another aspect, there is provided an apparatus comprising means for determining, based on an expiration of at least one time alignment timer of at least two time alignment timers, whether to flush one or more hybrid automatic repeat request, HARQ, buffers.

According to another aspect, there is provided a method comprising: determining, based on an expiration of at least one time alignment timer of at least two time alignment timers, whether to flush one or more hybrid automatic repeat request, HARQ, buffers.

According to another aspect, there is provided a computer program comprising instructions which, when executed by an apparatus, cause the apparatus to perform at least the following: determining, based on an expiration of at least one time alignment timer of at least two time alignment timers, whether to flush one or more hybrid automatic repeat request, HARQ, buffers.

According to another aspect, there is provided a computer readable medium comprising program instructions which, when executed by an apparatus, cause the apparatus to perform at least the following: determining, based on an expiration of at least one time alignment timer of at least two time alignment timers, whether to flush one or more hybrid automatic repeat request, HARQ, buffers.

According to another aspect, there is provided a non-transitory computer readable medium comprising program instructions which, when executed by an apparatus, cause the apparatus to perform at least the following: determining, based on an expiration of at least one time alignment timer of at least two time alignment timers, whether to flush one or more hybrid automatic repeat request, HARQ, buffers.

### LIST OF DRAWINGS

In the following, various example embodiments will be described in greater detail with reference to the accompanying drawings, in which

FIG. 1 illustrates an example of a cellular communication network;

FIG. 2 illustrates the concept of timing advance;

FIG. 3 illustrates simultaneous (or parallel) multi-panel uplink transmission;

FIG. 4 illustrates a flow chart according to an example embodiment;

FIG. 5 illustrates an example according to an example embodiment;

FIG. 6 illustrates a flow chart according to an example embodiment;

FIG. 7 illustrates a flow chart according to an example embodiment;

FIG. 8 illustrates a flow chart according to an example embodiment;

FIG. 9 illustrates a flow chart according to an example embodiment;

FIG. 10 illustrates a flow chart according to an example embodiment;

FIG. 11 illustrates a flow chart according to an example embodiment;

FIG. 12 illustrates an example according to an example embodiment;

FIG. 13 illustrates a flow chart according to an example embodiment; and

FIG. 14 illustrates an example embodiment of an apparatus.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

In the following, different example embodiments will be described using, as an example of an access architecture to which the example embodiments may be applied, a radio access architecture based on long term evolution advanced (LTE Advanced, LTE-A), new radio (NR, 5G), beyond 5G, or sixth generation (6G) without restricting the example embodiments to such an architecture, however. It is obvious for a person skilled in the art that the example embodiments may also be applied to other kinds of communications networks having suitable means by adjusting parameters and procedures appropriately. Some examples of other options for suitable systems may be the universal mobile telecommunications system (UMTS) radio access network (UTRAN or E-UTRAN), long term evolution (LTE, substantially the same as E-UTRA), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

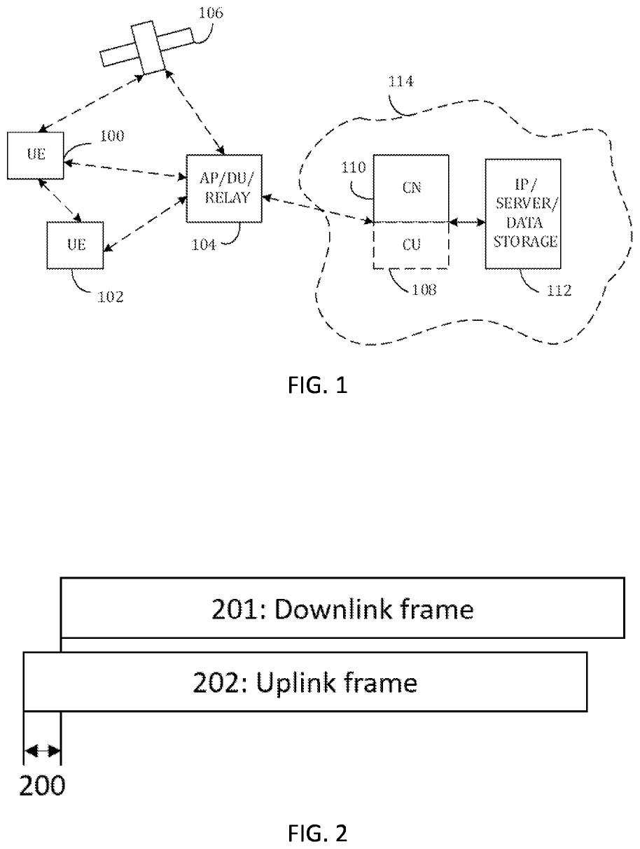

FIG. 1 depicts examples of simplified system architectures showing some elements and functional entities, all being logical units, whose implementation may differ from what is shown. The connections shown in FIG. 1 are logical connections; the actual physical connections may be different. It is apparent to a person skilled in the art that the system may also comprise other functions and structures than those shown in FIG. 1.

The example embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 and 102 configured to be in a wireless connection on one or more communication channels in a radio cell with an access node 104, such as an evolved Node B (abbreviated as eNB or eNodeB) or a next generation Node B (abbreviated as gNB or gNodeB), providing the radio cell. The physical link from a user device to an access node may be called uplink (UL) or reverse link, and the physical link from the access node to the user device may be called downlink (DL) or forward link. A user device may also communicate directly with another user device via sidelink (SL) communication. It should be appreciated that access nodes or their functionalities may be implemented by using any node, host, server or access point etc. entity suitable for such a usage.

A communication system may comprise more than one access node, in which case the access nodes may also be configured to communicate with one another over links, wired or wireless, designed for the purpose. These links may be used for signaling purposes. The access node may be a computing device configured to control the radio resources of communication system it is coupled to. The access node may also be referred to as a base station, a base transceiver station (BTS), an access point or any other type of interfacing device including a relay station capable of operating in a wireless environment. The access node may include or be coupled to transceivers. From the transceivers of the access node, a connection may be provided to an antenna unit that establishes bi-directional radio links to user devices. The antenna unit may comprise a plurality of antennas or antenna elements. The access node may further be connected to a core network 110 (CN or next generation core NGC). Depending on the system, the counterpart on the CN side may be a serving gateway (S-GW, routing and forwarding user data packets), packet data network gateway (P-GW) for providing connectivity of user devices to external packet data networks, user plane function (UPF), mobility management entity (MME), access and mobility management function (AMF), or location management function (LMF), etc.

The user device illustrates one type of an apparatus to which resources on the air interface may be allocated and assigned, and thus any feature described herein with a user device may be implemented with a corresponding apparatus, such as a relay node.

An example of such a relay node may be a layer 3 relay (self-backhauling relay) towards the access node. The self-backhauling relay node may also be called an integrated access and backhaul (IAB) node. The IAB node may comprise two logical parts: a mobile termination (MT) part, which takes care of the backhaul link(s) (i.e., link(s) between IAB node and a donor node, also known as a parent node) and a distributed unit (DU) part, which takes care of the access link(s), i.e., child link(s) between the IAB node and user device(s), and/or between the IAB node and other IAB nodes (multi-hop scenario).

Another example of such a relay node may be a layer 1 relay called a repeater. The repeater may amplify a signal received from an access node and forward it to a user device, and/or amplify a signal received from the user device and forward it to the access node.

The user device may also be called a subscriber unit, mobile station, remote terminal, access terminal, user terminal, terminal device, or user equipment (UE) just to mention but a few names or apparatuses. The user device may refer to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, multimedia device, reduced capability (RedCap) device, wireless sensor device, or any device integrated in a vehicle.

It should be appreciated that a user device may also be a nearly exclusive uplink-only device, of which an example may be a camera or video camera loading images or video clips to a network. A user device may also be a device having capability to operate in Internet of Things (IoT) network which is a scenario in which objects may be provided with the ability to transfer data over a network without requiring human-to-human or human-to-computer interaction. The user device may also utilize cloud. In some applications, a user device may comprise a small portable or wearable device with radio parts (such as a watch, earphones or eyeglasses) and the computation may be carried out in the cloud or in another user device. The user device (or in some example embodiments a layer 3 relay node) may be configured to perform one or more of user equipment functionalities.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question may have inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input—multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications may support a wide range of use cases and related applications including video streaming, augmented reality, different ways of data sharing and various forms of machine type applications (such as (massive) machine-type communications (mMTC), including vehicular safety, different sensors and real-time control. 5G may have multiple radio interfaces, namely below 6 GHz, cmWave and mmWave, and also being integrable with existing legacy radio access technologies, such as the LTE. Integration with the LTE may be implemented, at least in the early phase, as a system, where macro coverage may be provided by the LTE, and 5G radio interface access may come from small cells by aggregation to the LTE. In other words, 5G may support both inter-RAT operability (such as LTE-5G) and inter-RI operability (inter-radio interface operability, such as below 6 GHz-cmWave-mmWave). One of the concepts considered to be used in 5G networks may be network slicing, in which multiple independent and dedicated virtual sub-networks (network instances) may be created within the substantially same infrastructure to run services that have different requirements on latency, reliability, throughput and mobility.

The current architecture in LTE networks may be fully distributed in the radio and fully centralized in the core network. The low latency applications and services in 5G may need to bring the content close to the radio which leads to local break out and multi-access edge computing (MEC). 5G may enable analytics and knowledge generation to occur at the source of the data. This approach may need leveraging resources that may not be continuously connected to a network such as laptops, smartphones, tablets and sensors. MEC may provide a distributed computing environment for application and service hosting. It may also have the ability to store and process content in close proximity to cellular subscribers for faster response time. Edge computing may cover a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system may also be able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head (RRH) or a radio unit (RU), or an access node comprising radio parts. It may also be possible that node operations are distributed among a plurality of servers, nodes or hosts. Carrying out the RAN real-time functions at the RAN side (in a distributed unit, DU 104) and non-real time functions in a centralized manner (in a central unit, CU 108) may be enabled for example by application of cloudRAN architecture.

It should also be understood that the distribution of labour between core network operations and access node operations may differ from that of the LTE or even be non-existent. Some other technology advancements that may be used include big data and all-IP, which may change the way networks are being constructed and managed. 5G (or new radio, NR) networks may be designed to support multiple hierarchies, where MEC servers may be placed between the core and the access node. It should be appreciated that MEC may be applied in 4G networks as well.

5G may also utilize non-terrestrial communication, for example satellite communication, to enhance or complement the coverage of 5G service, for example by providing backhauling. Possible use cases may be providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano)satellites are deployed). At least one satellite 106 in the mega-constellation may cover several satellite-enabled network entities that create on-ground cells. The on-ground cells may be created through an on-ground relay node 104 or by a gNB located on-ground or in a satellite.

6G networks are expected to adopt flexible decentralized and/or distributed computing systems and architecture and ubiquitous computing, with local spectrum licensing, spectrum sharing, infrastructure sharing, and intelligent automated management underpinned by mobile edge computing, artificial intelligence, short-packet communication and blockchain technologies. Key features of 6G may include intelligent connected management and control functions, programmability, integrated sensing and communication, reduction of energy footprint, trustworthy infrastructure, scalability and affordability. In addition to these, 6G is also targeting new use cases covering the integration of localization and sensing capabilities into system definition to unifying user experience across physical and digital worlds.

It is obvious for a person skilled in the art that the depicted system is only an example of a part of a radio access system and in practice, the system may comprise a plurality of access nodes, the user device may have access to a plurality of radio cells and the system may also comprise other apparatuses, such as physical layer relay nodes or other network elements, etc. At least one of the access nodes may be a Home eNodeB or a Home gNodeB.

Furthermore, the access node may also be split into: a radio unit (RU) comprising a radio transceiver (TRX), i.e., a transmitter (Tx) and a receiver (Rx); one or more distributed units (DUs) that may be used for the so-called Layer 1 (L1) processing and real-time Layer 2 (L2) processing; and a central unit (CU) (also known as a centralized unit) that may be used for non-real-time L2 and Layer 3 (L3) processing. The CU may be connected to the one or more DUs for example by using an F1 interface. Such a split may enable the centralization of CUs relative to the cell sites and DUs, whereas DUs may be more distributed and may even remain at cell sites. The CU and DU together may also be referred to as baseband or a baseband unit (BBU). The CU and DU may also be comprised in a radio access point (RAP).

The CU may be defined as a logical node hosting higher layer protocols, such as radio resource control (RRC), service data adaptation protocol (SDAP) and/or packet data convergence protocol (PDCP), of the access node. The DU may be defined as a logical node hosting radio link control (RLC), medium access control (MAC) and/or physical (PHY) layers of the access node. The operation of the DU may be at least partly controlled by the CU. The CU may comprise a control plane (CU-CP), which may be defined as a logical node hosting the RRC and the control plane part of the PDCP protocol of the CU for the access node. The CU may further comprise a user plane (CU-UP), which may be defined as a logical node hosting the user plane part of the PDCP protocol and the SDAP protocol of the CU for the access node.

Cloud computing platforms may also be used to run the CU and/or DU. The CU may run in a cloud computing platform, which may be referred to as a virtualized CU (vCU). In addition to the vCU, there may also be a virtualized DU (vDU) running in a cloud computing platform. Furthermore, there may also be a combination, where the DU may use so-called bare metal solutions, for example application-specific integrated circuit (ASIC) or customer-specific standard product (CSSP) system-on-a-chip (SoC) solutions. It should also be understood that the distribution of labour between the above-mentioned access node units, or different core network operations and access node operations, may differ.

Additionally, in a geographical area of a radio communication system, a plurality of different kinds of radio cells as well as a plurality of radio cells may be provided. Radio cells may be macro cells (or umbrella cells) which may be large cells having a diameter of up to tens of kilometers, or smaller cells such as micro-, femto- or picocells. The access node(s) of FIG. 1 may provide any kind of these cells. A cellular radio system may be implemented as a multilayer network including several kinds of radio cells. In multilayer networks, one access node may provide one kind of a radio cell or radio cells, and thus a plurality of access nodes may be needed to provide such a network structure.

For fulfilling the need for improving the deployment and performance of communication systems, the concept of “plug-and-play” access nodes may be introduced. A network which may be able to use “plug-and-play” access nodes, may include, in addition to Home eNodeBs or Home gNodeBs, a Home Node B gateway, or HNB-GW (not shown in FIG. 1). An HNB-GW, which may be installed within an operator's network, may aggregate traffic from a large number of Home eNodeBs or Home gNodeBs back to a core network.

A UE that is far away from a transmission and reception point (TRP) may encounter a larger propagation delay than another UE that is closer to the TRP. Due to the larger propagation delay, the uplink transmission of the more distant UE may need to be transmitted in advance as compared to the uplink transmission of the closer UE, so that the uplink transmissions arrive at the TRP at the same time. Herein a TRP may refer to any entity, for example a network node or a remote radio head (RRH), which is capable of transmitting and/or receiving a radio signal.

FIG. 2 illustrates the concept of timing advance. A timing advance (TA) 200 is a negative offset at the UE between the start of a received downlink (DL) frame 201 and a transmitted uplink (UL) frame 202. The timing advance can be used to take into account the propagation delay between the UE and the TRP. This offset may be used to ensure that the DL and UL frames are synchronized at the TRP (in the time domain). Thus, the UE may adjust its uplink transmissions by sending uplink symbols in advance according to the amount of time defined by the timing advance.

TA adjustment may consist of two parts: 1) based on the network signaling of TA adjustment (e.g., a timing advance command) to the UE, and 2) autonomous UL transmit timing adjustment by the UE. In other words, once the UE has been assigned a TA value by the network (e.g., via a timing advance command), the UE may track its DL timing and adjust the UL transmit timing to be within a set threshold.

The timing of UL transmissions may be controlled by the network by means of regularly provided timing advance commands (TAC) in a closed-loop manner. Upon reception of a TAC from the network for a given timing advance group (TAG), the UE may adjust uplink timing for physical uplink shared channel (PUSCH), physical uplink control channel (PUCCH), and/or sounding reference signal (SRS) transmissions on the serving cells in the TAG based on the received TAC and a fixed offset value N_{TA,offset}.

Downlink, uplink, and sidelink transmissions may be organized into radio frames with a duration of 10 ms, wherein a given radio frame comprises ten subframes of 1 ms. Uplink frame number i for transmission from the UE starts before the start of the corresponding downlink frame at the UE according to a timing advance, which may be calculated for example as T_{TA}=(N_{TA}+N_{TA,offset})T_{c}.

T_{TA} is the calculated timing advance between uplink and downlink to be applied by the UE. N_{TA} is a timing advance value provided by the network (e.g., broadcast or provided in the TAC). N_{TA,offset} is a fixed offset value that may vary according to different frequency bands and subcarrier spacing. T_{c} is a basic time unit for NR, for example 0.509 ns.

Currently, there are two ways to deliver TA adjustment to a UE: 1) via a random-access response (RAR) or MsgB as part of a random-access procedure, or 2) via MAC control element (MAC CE).

In the first option (i.e., RAR or MsgB), the timing correction may be calculated by the network based on a random-access preamble or MsgA received from the UE. The UE determines the timing advance value from two different MAC layer commands depending on the situation. For the first uplink message after the random-access procedure, the UE applies the timing advance value that it extracts from the RAR or MsgB. After that, the UE may apply the timing advance value that it extracts from a timing advance MAC CE, if the UE receives such a MAC CE.

In the second option (i.e., MAC CE), TA estimation is done at the network based on one or more reference signals, such as a demodulation reference signal (DMRS) or SRS transmitted from the UE. As mentioned above, the UE may adjust UL transmission timing based on RAR during the random-access procedure. Once the initial attach is complete, the UE may adjust UL transmission based on the MAC CE timing advance. The timing advance command field may be, for example, 6 bits, which means 64 steps in total ranging from −32 to 32 T_{c} in real timing. If T_{c} is 0.509 ns, the range of the physical timing may be −16.3 μs to 16.3 μs with 15 kHz subcarrier spacing.

A TAG may comprise a group of serving cells, which may be configured by RRC, and which, for the cells with an UL configured, may use the same timing reference cell and the same timing advance value. A TAG containing the special cell (SpCell) of a MAC entity is referred to as a primary timing advance group (PTAG), whereas the term secondary timing advance group (STAG) refers to other TAGs.

A parameter called timeAlignmentTimer (per TAG) may be configured via RRC to control how long the MAC entity considers the serving cells belonging to the associated TAG to be uplink time aligned.

When a timing advance command MAC CE is received, and if an N_{TA} has been maintained with the indicated TAG, the MAC entity may apply the timing advance command for the indicated TAG, and start or restart the timeAlignmentTimer associated with the indicated TAG.

When a timing advance command is received in a RAR for a serving cell belonging to a TAG or in a MsgB for an SpCell, and if the random-access preamble was not selected by the MAC entity among the contention-based random access preamble, the MAC entity may apply the timing advance command for this TAG, and start or restart the timeAlignmentTimer associated with this TAG.

If the timeAlignmentTimer associated with this TAG is not running, the MAC entity may: apply the timing advance command for this TAG, and start the timeAlignmentTimer associated with this TAG. When the contention resolution is considered not successful, or when the contention resolution is considered successful for system information (SI) request, after transmitting hybrid automatic repeat request (HARQ) feedback for MAC protocol data unit (PDU) including the UE Contention Resolution Identity MAC CE, the MAC entity may stop the timeAlignmentTimer associated with this TAG.

Otherwise, the MAC entity may ignore the received timing advance command received in the RAR message.

When an absolute timing advance command is received in response to a MsgA transmission including a cell radio network temporary identifier (C-RNTI) MAC CE, the MAC entity may apply the timing advance command for PTAG, and start or restart the timeAlignmentTimer associated with the PTAG.

When the timeAlignmentTimer expires, and if the timeAlignmentTimer is associated with the PTAG, the MAC entity may flush all HARQ buffers for all serving cells, notify RRC to release PUCCH for all serving cells (if configured), notify RRC to release SRS for all serving cells (if configured), clear any configured downlink assignments and configured uplink grants, clear any PUSCH resource for semi-persistent channel state information (CSI) reporting, consider all running timeAlignmentTimers as expired, and maintain N_{TA} of all TAGs. Herein flushing the HARQ buffers may mean emptying the HARQ buffers. A UE may be configured with multiple HARQ processes, each of which has or is associated with a buffer. This HARQ buffer may be used to buffer a transport block (TB) (or packet), corresponding to a HARQ process, for example so that a retransmission of this TB is possible based on the gNB request, if the gNB has not been able to correctly receive the first transmission.

Otherwise, if the timeAlignmentTimer is associated with an STAG, then for all serving cells belonging to this TAG, the MAC entity may perform the following when the timeAlignmentTimer expires: flush all HARQ buffers, notify RRC to release PUCCH (if configured), notify RRC to release SRS (if configured), clear any configured downlink assignments and configured uplink grants, clear any PUSCH resource for semi-persistent CSI reporting, and maintain N_{TA} of this TAG.

When the MAC entity stops uplink transmissions for a secondary cell (SCell) due to the fact that the maximum uplink transmission timing difference between TAGs of the MAC entity or the maximum uplink transmission timing difference between TAGs of any MAC entity of the UE is exceeded, the MAC entity may consider the timeAlignmentTimer associated with the SCell as expired.

The MAC entity may not perform any uplink transmission on a serving cell, except the random-access preamble and MsgA transmission, when the timeAlignmentTimer associated with the TAG, to which this serving cell belongs, is not running. Furthermore, when the timeAlignmentTimer associated with the PTAG is not running, the MAC entity may not perform any uplink transmission on any serving cell, except the random-access preamble and MsgA transmission on the SpCell.

In NR Release 18 and beyond, simultaneous (or parallel) UL transmission schemes may be specified considering capacity and reliability aspects (e.g., PUCCH repetition, PUSCH repetition) and enabling uncoordinated UL transmissions expected in multi-DCI for multi-TRP operation (e.g., PUCCH/PUSCH, PUCCH/PUCCH, and other UL overlapping channels). DCI is an abbreviation for downlink control information. Simultaneous UL transmission may involve allowing simultaneous or parallel PUCCH/PUSCH and PUSCH/PUCCH/SRS transmissions from two or more UE antenna panels (e.g., using different UL beams in FR2). Multi-TRP operation may support two or more TRPs.

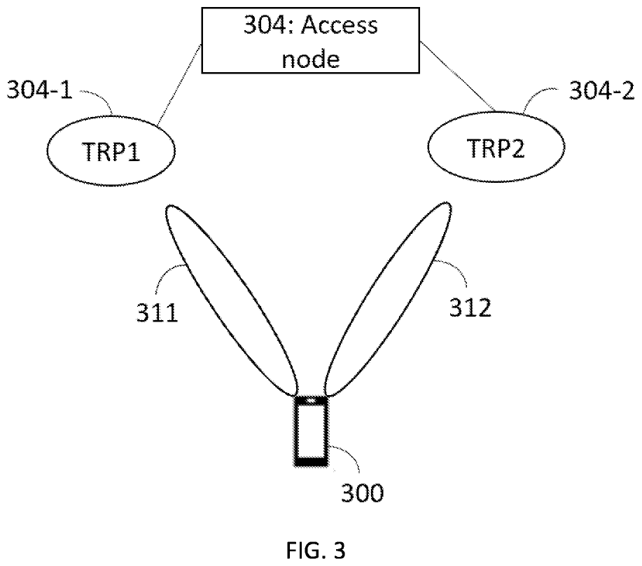

FIG. 3 illustrates simultaneous (or parallel) multi-panel UL transmission for multi-TRP operation. A UE 300 transmits a first uplink transmission to a first TRP 304-1 via a first uplink beam 311. The UE 300 transmits a second uplink transmission to a second TRP 304-2 via a second uplink beam 312, wherein the first uplink transmission and the second uplink transmission overlap at least partially in time. It should be noted that also more than two uplink transmissions may be transmitted simultaneously to more than two TRPs. The first uplink transmission and the second uplink transmission may be transmitted from different UE antenna panels. For example, the first uplink transmission may be transmitted from a first antenna panel of the UE 300, and the second uplink transmission may be transmitted from a second antenna panel of the UE 300. The first TRP 304-1 and the second TRP 304-2 may belong to a single access node 304 (e.g., gNB), or they may belong to different access nodes (e.g., gNBs). The UE 300 in FIG. 3 may correspond to the UE 100 in FIG. 1. Furthermore, the access node 304 in FIG. 3 may correspond to the access node 104 in FIG. 1.

It should be noted that herein an uplink (UL) beam may also refer to spatial relation info, (separate) UL transmission configuration indicator (TCI) state, joint or common TCI state, spatial filter, power control information (or power control parameters set), antenna panel or panel identifier (ID), etc. In other words, these terms may be used interchangeably herein. Furthermore, a TRP may be identified by at least one of the following: an SRS resource set, a beam failure detection reference signal (BFD-RS) set, a subset or set of UL beams, a control resource set pool index (CORESETPoolIndex) (if configured), and/or a physical cell identity (PCI). Furthermore, it should be noted that a given UE antenna panel may be identified by a panel ID. Alternatively, or additionally, a given antenna panel may be identified or associated by at least one (DL) reference signal or by an UL beam.

For NR Release 18, there is an objective of including two TAs for both intra-cell and inter-cell multi-DCI multi-TRP operation. This feature may be referred to as a multi-TA enhancement or two-TA enhancement. However, this feature may have an impact on existing/legacy procedures.

For multi-DCI, there may be: multiple physical downlink control channels (PDCCHs), each scheduling a respective PDSCH or UL transmission, where each PDSCH or UL transmission is transmitted from or to a separate TRP; and a higher layer parameter coresetPoolIndex identifying a given TRP. Multi-DCI may be more suitable for non-ideal backhaul (but could also be used for ideal backhaul cases).

In contrast, for single-DCI, multi-TRP DL/UL transmission or repetition operation is scheduled with one DCI. Single-DCI may be more suitable for ideal backhaul.

Some example embodiments are related to time alignment operations and procedures, and provide solutions to account for the impact of introducing the multi-TA enhancement for multi-TRP operation.

Some example embodiments are described below using principles and terminology of NR technology without limiting the example embodiments to NR communication systems, however.

Some example embodiments may define timeAlignmentTimer-related operations and procedures considering multi-TA operation for multi-TRP. For example, the operation of whether or not to flush HARQ buffers for one or more cells is defined herein.

In some example embodiments, a UE supporting multi-DCI-based multi-TRP operation (inter-cell or intra-cell) may be configured with at least two TAGs per cell, each TAG corresponding to a TRP, PCI, or CORESETPoolIndex, and TAGs may be applicable for one or more (serving) cells (precondition for supporting multi-TA operation at the UE). Herein the term “cell” may refer to a radio cell.

The UE may assume a time alignment timer (timeAlignmentTimer) separately for each TRP/PCI/CORESETPoolIndex with the following considerations.

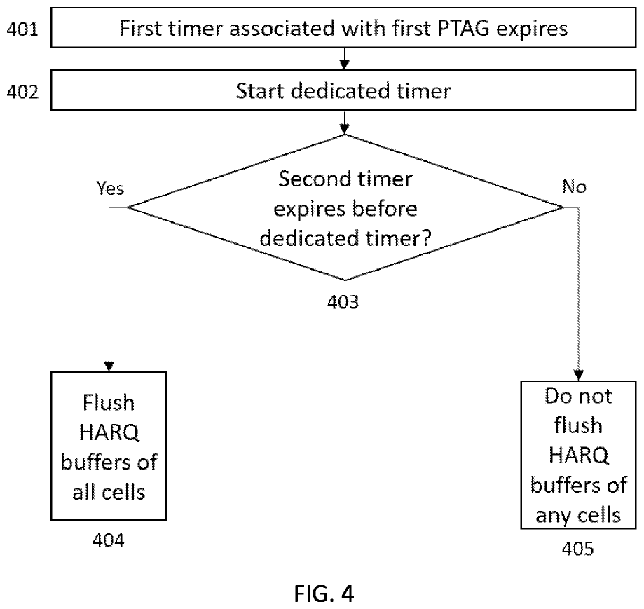

In an example embodiment, for the case with at least two primary TAGs (which may be associated to at least one same serving cell or to different cells), when a time alignment timer expires for one or both primary TAG(s), each corresponding to a TRP/PCI/CORESETPoolIndex: if the time alignment timers of the primary TAGs expire at (substantially) the same time, or at different times but within a pre-defined or configured period of time (e.g., within a certain threshold), the UE may flush the HARQ buffers of all serving cells configured (and active) for the UE. To achieve this, one way would be as follows: the UE may be configured with a dedicated timer that is triggered whenever one of the time alignment timers expires, and if the second time alignment timer expires before the dedicated timer expires, the UE may flush HARQ buffers of all of its serving cells and stop the dedicated timer. The dedicated timer may also be referred to as a third timer herein. Otherwise, if the second time alignment timer does not expire before the dedicated timer expires, the UE may not flush HARQ buffers of any cells. This is illustrated in FIG. 4.

FIG. 4 illustrates a flow chart according to an example embodiment of a method performed by an apparatus such as, or comprising, or comprised in, a user device.

Referring to FIG. 4, in block 401, the apparatus detects that a first time alignment timer of at least two time alignment timers expires. The first time alignment timer is associated with a first PTAG.

In block 402, a dedicated timer is started in response to the expiration of the first time alignment timer. The dedicated timer may also be referred to as a third timer herein. The third timer may correspond to a pre-defined time period (threshold), i.e., the third timer may be configured to expire upon reaching a time value corresponding to the pre-defined time period.

In block 404, if a second time alignment timer associated with a second PTAG expires before the dedicated timer (third timer) expires (403: yes), i.e., the second time alignment timer expires within the pre-defined time period relative to the expiration of the first time alignment timer, then the apparatus flushes the HARQ buffer(s) corresponding to a plurality of cells. The plurality of cells may refer to all serving cells configured (and active) for the apparatus.

Alternatively, in block 405, the second time alignment timer does not expire before the dedicated timer (third timer) expires (403: no), i.e., the second time alignment timer does not expire within the pre-defined time period relative to the expiration of the first time alignment timer, then the apparatus does not flush HARQ buffer(s) of any cells.

In other words, the determination of whether to flush the HARQ buffers may be based on the expiration of the first time alignment timer relative to the expiration of the second time alignment timer, i.e., based on whether the second time alignment timer expires before the dedicated timer (third timer) expires.

Herein the terms “first time alignment timer” and “second time alignment timer” are used to distinguish the timers, and they do not necessarily mean a specific order or specific identifier numbers of the timers.

Such use of the relative expiration of one time alignment timer with respect to another time alignment timer may be beneficial given the following. If the two time alignment timers (e.g., each corresponding to a TRP) expire within a short period of time, there would not be enough time to acquire and adjust the first TA before the second time alignment timer expires. This should be seen as there is no synchronized UL available, and thus there should be flushing of all HARQ buffers. On the other hand, if the second time alignment timer expires after the pre-defined time period from the expiration of the first time alignment timer, there would be enough time to acquire and adjust the first TA (before the second time alignment timer expires). Consequently, there would be at least one synchronized UL available, and thus there would be no need to do the flushing of HARQ buffers. In this case, HARQ retransmission towards another TRP than the TRP for initial transmission is assumed.

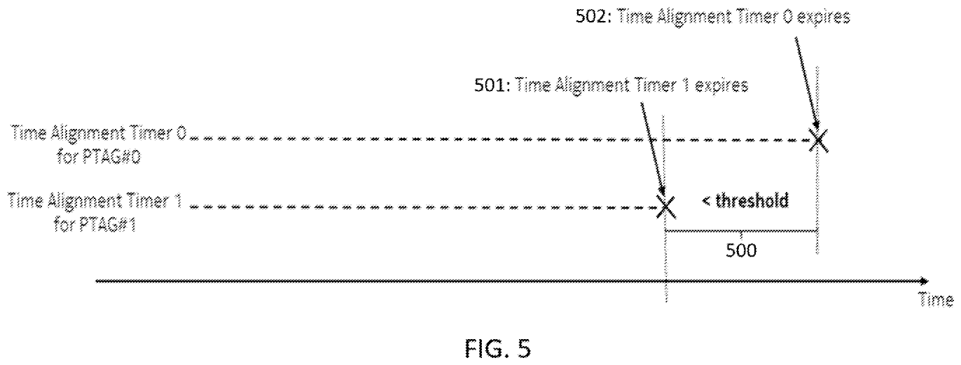

FIG. 5 illustrates an example corresponding to the example embodiment of FIG. 4, wherein a UE is configured (e.g., via RRC) with a threshold (pre-defined time period) related to the expiration of two time alignment timers (time alignment timer 0 and time alignment timer 1). In this example, since time alignment timer 1 and time alignment timer 0 expire 501, 502 within a time period 500 that is shorter than the threshold, and these timers correspond to primary TAGs, the UE flushes HARQ buffers for all serving cells configured (and active) for the UE. Time alignment timer 1 may also be referred to as a first time alignment timer herein, and time alignment timer 0 may also be referred to as a second time alignment timer herein. TAG #1 may also be referred to as a first timing advance group herein, and TAG #0 may also be referred to as a second timing advance group herein.

Although FIG. 5 illustrates time alignment timer 1 expiring before time alignment timer 0, it is also possible that time alignment timer 0 may expire before time alignment timer 1. In this case, after the expiry of time alignment timer 0, if time alignment timer 1 expires within a time period that is shorter than the threshold, and these timers correspond to primary TAGs, then the UE may flush HARQ buffers for all serving cells configured (and active) for the UE. In other words, the relative expiration of the time alignment timers may be used to trigger flushing the HARQ buffers for all of the serving cells regardless of the specific order in which the time alignment timers expire.

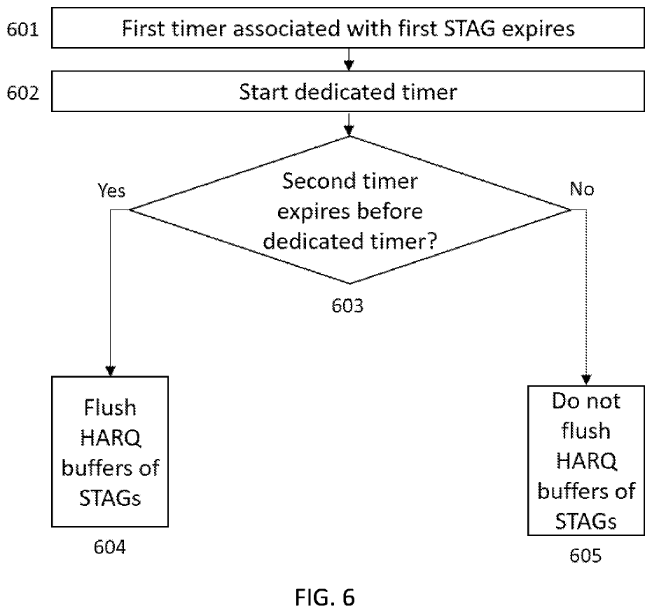

In an example embodiment, for the case with at least two secondary TAGs (which may be associated to at least one same serving cell or to different cells), when a time alignment timer expires for both secondary TAGs, each corresponding to a TRP/PCI/CORESETPoolIndex: if the time alignment timers of secondary TAGs expire at (substantially) the same time, or at different times but within a pre-defined or configured period of time (i.e., within a certain threshold), the UE may flush the HARQ buffers of these TAGs. To achieve this, similar way(s) as described for the primary TAGs may also be adopted here. This is illustrated in FIG. 6.

FIG. 6 illustrates a flow chart according to an example embodiment of a method performed by an apparatus such as, or comprising, or comprised in, a user device.

Referring to FIG. 6, in block 601, the apparatus detects that a first time alignment timer of at least two time alignment timers expires. The first time alignment timer is associated with a first STAG.

In block 602, a dedicated timer is started in response to the expiration of the first time alignment timer. The dedicated timer may also be referred to as a third timer herein. The third timer may correspond to a pre-defined time period (threshold), i.e., the third timer may be configured to expire upon reaching a time value corresponding to the pre-defined time period.

In block 604, if a second time alignment timer associated with a second STAG expires before the dedicated timer (third timer) expires (603: yes), i.e., the second time alignment timer expires within the pre-defined time period relative to the expiration of the first time alignment timer, then the apparatus flushes the HARQ buffer(s) corresponding to the first STAG and the second STAG.

Alternatively, in block 605, the second time alignment timer does not expire before the dedicated timer (third timer) expires (603: no), i.e., the second time alignment timer does not expire within the pre-defined time period relative to the expiration of the first time alignment timer, then the apparatus does not flush the HARQ buffer(s) of the STAGs.

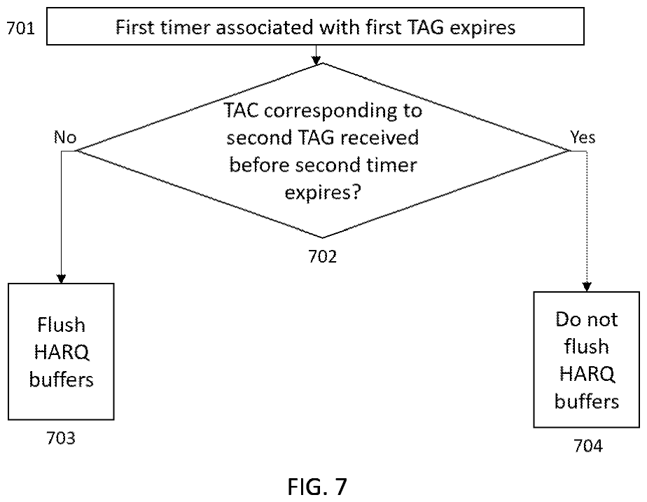

In an example embodiment (see FIG. 7), for the case with two TAGs, each corresponding to a TRP/PCI/CORESETPoolIndex: if the time alignment timer of a first TAG or (corresponding to) a first TRP expires, and the UE does not receive a TAC corresponding to the second TAG or TRP before the expiry of the time alignment timer of the second TAG, the UE may flush the HARQ buffers of all serving cells configured (and active) for the UE, if the TAGs are primary TAGs. If the two TAGs are secondary TAGs, the UE may flush the HARQ buffers of the cells in these TAGs. Otherwise, if the time alignment timer of the first TAG or (corresponding to) the first TRP expires, and the UE receives a TAC corresponding to the second TAG before the expiry of the time alignment timer of the second TAG, the UE does not flush the HARQ buffers of any cells if the TAGs are primary TAGs. If the two TAGs are secondary TAGs, the UE does not flush the HARQ buffers of any cells in these TAGs. The reception of a TAC may be corresponding to the reception of the last symbol of the physical downlink control channel (PDCCH) scheduling the physical downlink shared channel (PDSCH) carrying the TAC or the last symbol of the PDSCH carrying the TAC (including the RAR), or the first or last symbol of the PUCCH/PUSCH carrying the HARQ acknowledgement (HARQ-ACK) corresponding to the PDSCH containing the TAC, or a certain period before or after the reception or transmission of this PDCCH, PDSCH or PUCCH/PUSCH.

FIG. 7 illustrates a flow chart according to an example embodiment of a method performed by an apparatus such as, or comprising, or comprised in, a user device.

Referring to FIG. 7, in block 701, the apparatus detects that a first time alignment timer of at least two time alignment timers expires. The first time alignment timer is associated with a first TAG.

In block 703, after the expiration of the first time alignment timer, if a TAC corresponding to a second TAG is not received before a second time alignment timer associated with a second TAG expires, (702: no), then the apparatus flushes one or more HARQ buffers. If the first TAG and second TAG are PTAGs, then the apparatus may flush the HARQ buffer(s) of all serving cells configured (and active) for the apparatus. If the first TAG and the second TAG are STAGs, then the apparatus may flush the HARQ buffer(s) of the cells in the first TAG and the second TAG.

Alternatively, in block 704, if a TAC corresponding to a second TAG is received before the second time alignment timer associated with the second TAG expires, (702: yes), then the apparatus does not flush the one or more HARQ buffers. If the first TAG and the second TAG are primary TAGs, then the apparatus does not flush HARQ buffers of any cells. If the first TAG and the second TAG are secondary TAGs, the apparatus does not flush the HARQ buffers of any cells in these TAGs.

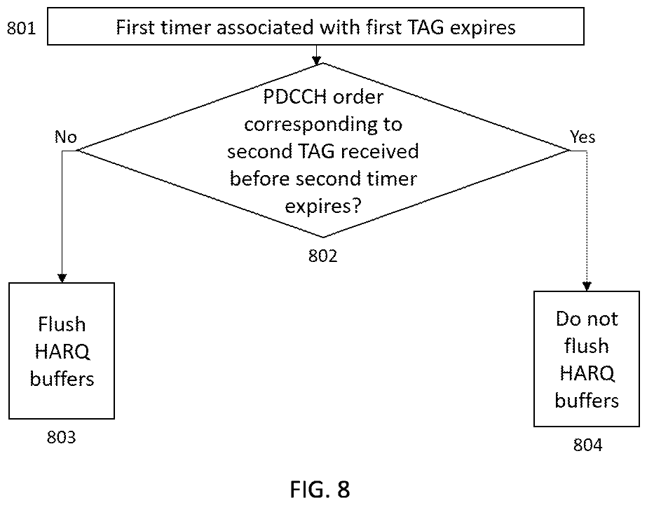

In an example embodiment (see FIG. 8), for the case with two TAGs, each corresponding to a TRP/PCI/CORESETPoolIndex: if the time alignment timer of a first TAG or (corresponding to) a first TRP expires, and the UE does not receive a PDCCH order corresponding to the second TAG or TRP before the expiry of the time alignment timer of the second TAG, the UE may flush the HARQ buffers of all serving cells configured (and active) for the UE, if the TAGs are primary TAGs. If the two TAGs are secondary TAGs, the UE may flush the HARQ buffers of the cells in these TAGs. Otherwise, if the time alignment timer of the first TAG or (corresponding to) the first TRP expires, and the UE receives the PDCCH order corresponding to the second TAG before the expiry of the time alignment timer of the second TAG, the UE does not flush the HARQ buffers of any cells if the TAGs are primary TAGs. If the two TAGs are secondary TAGs, the UE does not flush the HARQ buffers of any cells in these TAGs. The reference point for the reception of the PDCCH order in this case may be the last symbol of the PDCCH order, or the last symbol of the physical random-access channel (PRACH) or any of the random-access procedure messages (be it for 2-step or 4-step random access procedures) transmitted from or received by the UE (and triggered by the PDCCH order), or a certain period after the transmission or reception of any of these messages/signals.

FIG. 8 illustrates a flow chart according to an example embodiment of a method performed by an apparatus such as, or comprising, or comprised in, a user device.

Referring to FIG. 8, in block 801, the apparatus detects that a first time alignment timer of at least two time alignment timers expires. The first time alignment timer is associated with a first TAG.

In block 803, after the expiration of the first time alignment timer, if a PDCCH order corresponding to a second TAG is not received before a second time alignment timer associated with a second TAG expires, (802: no), then the apparatus flushes one or more HARQ buffers. If the first TAG and second TAG are PTAGs, then the apparatus may flush the HARQ buffer(s) of all serving cells configured (and active) for the apparatus. If the first TAG and the second TAG are STAGs, then the apparatus may flush the HARQ buffer(s) of the cells in the first TAG and the second TAG.

Alternatively, in block 804, if a PDCCH order corresponding to a second TAG is received before the second time alignment timer associated with the second TAG expires, (802: yes), then the apparatus does not flush the one or more HARQ buffers. If the first TAG and the second TAG are primary TAGs, then the apparatus does not flush HARQ buffers of any cells. If the first TAG and the second TAG are secondary TAGs, the apparatus does not flush the HARQ buffers of any cells in these TAGs.

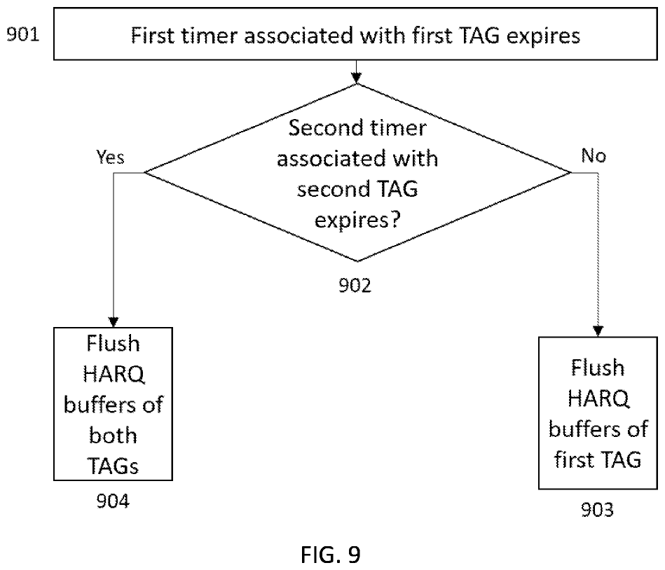

In an example embodiment, if for a cell there is a first TAG for which the time alignment timer is expired, and a second TAG for which the time alignment timer is not expired, the UE may not flush the HARQ buffers of this cell and may be configured to flush the HARQ buffers associated with the TAG associated with the expired time alignment timer. For example, in case the expired time alignment timer is associated with the first TAG, then the UE may flush the HARQ buffers associated with the first TAG, but not the HARQ buffers associated with the second TAG. This is illustrated in FIG. 9. This would allow retransmitting transport blocks (TBs) to the TRP, for which the corresponding time alignment timer has not expired.

FIG. 9 illustrates a flow chart according to an example embodiment of a method performed by an apparatus such as, or comprising, or comprised in, a user device.

Referring to FIG. 9, in block 901, the apparatus detects that a first time alignment timer of at least two time alignment timers expires. The first time alignment timer is associated with a first TAG.

In block 903, if a second time alignment timer associated with a second TAG is not expired (902: no), but the first time alignment timer is expired, then the apparatus flushes the HARQ buffer(s) of the first TAG (but not the HARQ buffers of the second TAG).

Alternatively, in block 904, if the second time alignment timer and the first time alignment timer are both expired (902: yes), then the apparatus flushes the HARQ buffer(s) of the first TAG and the second TAG.

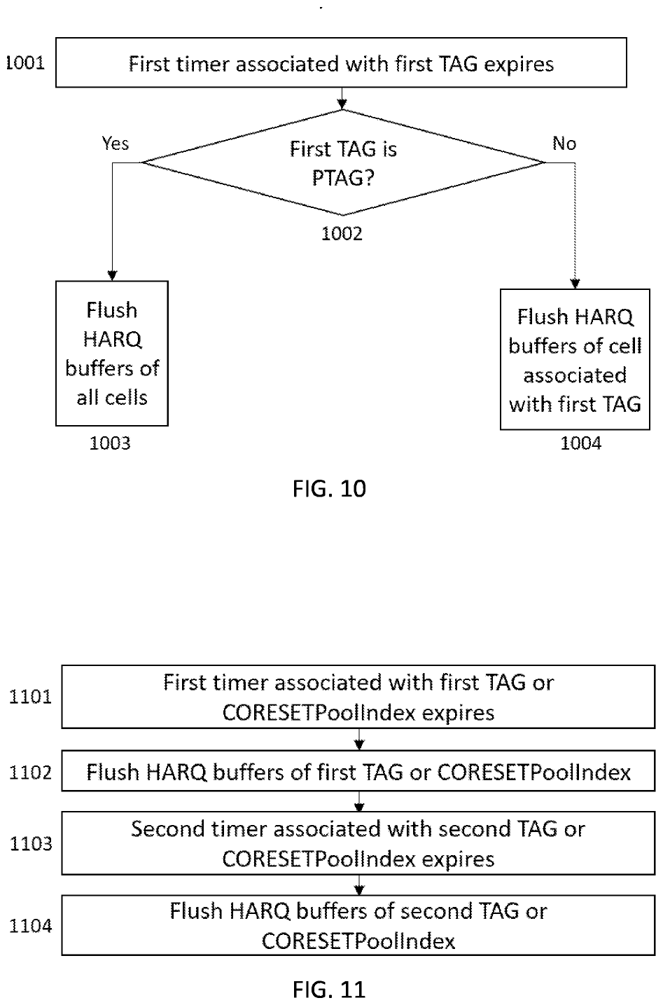

In an example embodiment, if a cell is configured with (or belongs to) a single TAG, for which the time alignment timer is expired, the UE may flush all the HARQ buffers of this cell. If this TAG is a primary TAG, i.e., if the cell is a special cell, which at least supports contention-based random access, the UE may flush the HARQ buffers of all serving cells configured (and active) for the UE. This is illustrated in FIG. 10.

FIG. 10 illustrates a flow chart according to an example embodiment of a method performed by an apparatus such as, or comprising, or comprised in, a user device.

Referring to FIG. 10, in block 1001, the apparatus detects that a first time alignment timer of at least two time alignment timers expires. The first time alignment timer is associated with a first TAG. In this example embodiment, a cell is configured with a single TAG (i.e., the first TAG).

In block 1003, if the first TAG is a PTAG (1002: yes), i.e., if the cell is a special cell, then the apparatus flushes the HARQ buffer(s) of all serving cells configured (and active) for the apparatus.

Alternatively, in block 1004, if the first TAG is not a PTAG (1002: no) then the apparatus flushes the HARQ buffer(s) of the cell associated with the first TAG. However, the apparatus does not flush the HARQ buffers of other cells, if the first TAG is not a PTAG.

In other words, the apparatus may flush the HARQ buffer(s) of one or more cells depending on whether the first TAG is a PTAG or not, wherein the one or more cells comprise at least the cell configured with the single TAG (i.e., the first TAG).

In an example embodiment, when the UE does not support HARQ retransmission via a different TRP than the TRP used for initial transmission (to allow UL retransmissions towards the same TRP used for the UL transmissions), the following considerations may be further defined. In an example embodiment, for a cell configured with two TAGs, each of which corresponds to or is associated with a TRP/PCI/CORESETPoolIndex: HARQ buffers of this cell may be split into two groups, each of which corresponds to a TAG or TRP/PCI/CORESETPoolIndex. Note that a cell may be configured with just one TAG. In this case, this TAG may correspond to or be associated with a default CORESETPoolIndex, such as CORESETPoolIndex 0. When the time alignment timer of one TAG or CORESETPoolIndex expires, for each cell configured with this TAG or CORESETPoolIndex, the HARQ buffers corresponding to this TAG or CORESETPoolIndex may be flushed. This is illustrated in FIG. 11.

FIG. 11 illustrates a flow chart according to an example embodiment of a method performed by an apparatus such as, or comprising, or comprised in, a user device.

In this example embodiment, a plurality of HARQ buffers of a cell are split into at least two groups.

Referring to FIG. 11, in block 1101, the apparatus detects that a first time alignment timer of at least two time alignment timers expires. The first time alignment timer may be associated with at least one of the following: a first timing advance group, a first transmission and reception point, a first cell identity, and/or a first control resource set pool index. Herein the term “cell identity” may refer to, for example, a physical cell identity (PCI).

In block 1102, in response to the expiration of the first time alignment timer, the apparatus flushes the first group of the at least two groups of HARQ buffers. The first group may be associated with at least one of the following: the first timing advance group, the first transmission and reception point, the first cell identity, and/or the first control resource set pool index associated with the expired first time alignment timer.

In block 1103, the apparatus detects that a second time alignment timer of the at least two time alignment timers expires. The second time alignment timer may be associated with at least one of the following: a second timing advance group, a second transmission and reception point, a second cell identity, and/or a second control resource set pool index.

In block 1104, in response to the expiration of the second time alignment timer, the apparatus flushes the second group of the at least two groups of HARQ buffers. The second group may be associated with at least one of the following: the second timing advance group, the second transmission and reception point, the second cell identity, and/or the second control resource set pool index associated with the expired second time alignment timer.

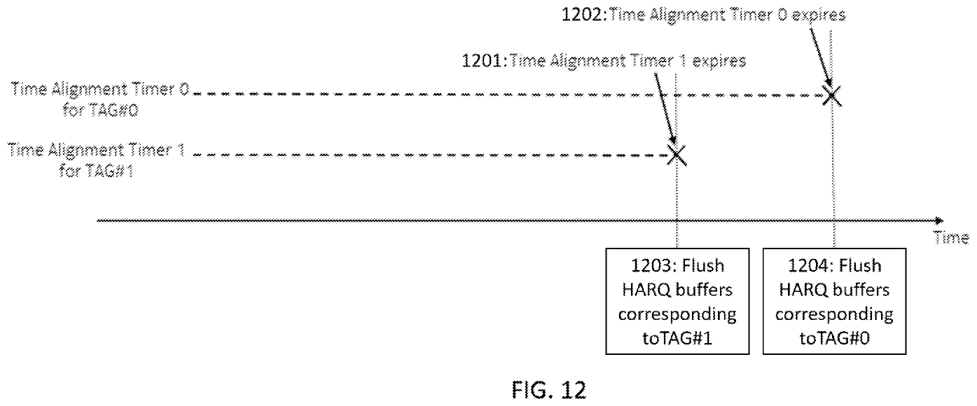

FIG. 12 illustrates an example corresponding to the example embodiment of FIG. 11, wherein a UE is configured (e.g., via RRC) such that HARQ buffers of a cell are split into two groups, namely group #0 and group #1, each of which corresponds to a TAG a CORESETPoolIndex. In this example, when time alignment timer 1 for TAG #1 expires 1201, the UE flushes 1203 HARQ buffers corresponding to TAG #1. When time alignment timer 0 for TAG #0 expires 1202, the UE flushes 1204 HARQ buffers corresponding to TAG #0. Time alignment timer 1 may also be referred to as a first time alignment timer herein, and time alignment timer 0 may also be referred to as a second time alignment timer herein. TAG #1 may also be referred to as a first timing advance group herein, and TAG #0 may also be referred to as a second timing advance group herein.

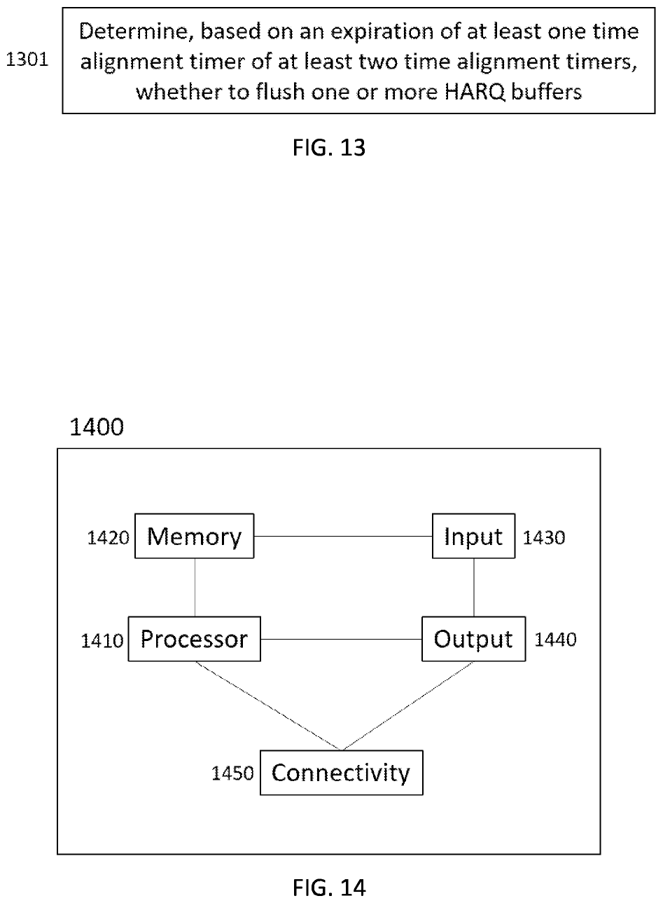

FIG. 13 illustrates a flow chart according to an example embodiment of a method performed by an apparatus such as, or comprising, or comprised in, a user device.

Referring to FIG. 13, in block 1301, the apparatus determines, based on an expiration of at least one time alignment timer of at least two time alignment timers, whether to flush one or more hybrid automatic repeat request, HARQ, buffers. The at least two time alignment timers may be configured to the apparatus by the network (e.g., by a gNB).

The at least two time alignment timers may comprise at least a first time alignment timer and a second time alignment timer. The first time alignment timer of the at least two time alignment timers may be associated with a first timing advance group, and the second time alignment timer of the at least two time alignment timers may be associated with a second timing advance group. The first timing advance group and the second timing advance group may be, for example, primary timing advance groups or secondary timing advance groups.

The first timing advance group may correspond to at least one of the following: a first transmission and reception point, a first cell identity, and/or a first control resource set pool index. The second timing advance group may correspond to at least one of the following: a second transmission and reception point, a second cell identity, and/or a second control resource set pool index.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

It should be noted that some example embodiments may also be applied for other operations than HARQ buffer flushing, such as:
1) Notifying RRC to release PUCCH for at least some serving cells, if configured. Assuming there would be association between PUCCHs and a TAG or CORESETPoolIndex/PCI/TRP, when the time alignment timer of a TAG expires, the UE may release the PUCCH corresponding to or associated with that TAG or CORESETPoolIndex/PCI/TRP.
2) Notifying RRC to release SRS for all serving cells, if configured. Assuming that there would be association between SRS resources or resource sets and a TAG or CORESETPoolIndex/PCI/TRP, when the time alignment timer of a TAG expires, the UE may release the SRS corresponding to or associated with that TAG or CORESETPoolIndex/PCI/TRP.
3) Clearing any configured downlink assignments and configured uplink grants. Assuming that there would be association between configured DL assignments/configured grants or their respective resources and a TAG or CORESETPoolIndex/PCI/TRP, when the time alignment timer of a TAG expires, the UE may clear the configured DL assignments/configured grants corresponding to or associated with that TAG or CORESETPoolIndex/PCI/TRP.
4) Clearing any PUSCH resource for semi-persistent CSI reporting. Assuming there would be association between PUSCH resources (for semi-persistent CSI) and a TAG or CORESETPoolIndex/PCI/TRP, when the time alignment timer of a TAG expires, the UE may clear the PUSCH resources for semi-persistent CSI corresponding to or associated with that TAG or CORESETPoolIndex/PCI/TRP.

Note that the conditions on which cell(s) the above would be applicable may be similar to the one defined for flushing HARQ buffers.

The blocks and related functions described above by means of FIGS. 4, 6-11 and 13 are in no absolute chronological order, and some of them may be performed simultaneously or in an order differing from the described one. Other functions can also be executed between them or within them, and other information may be sent, and/or other rules applied. Some of the blocks or part of the blocks can also be left out or replaced by a corresponding block or part of the block.

FIG. 14 illustrates an example embodiment of an apparatus 1400, which may be an apparatus such as, or comprising, or comprised in, a user device. The user device may correspond to one of the user devices 100, 102 of FIG. 1. The user device may also be called a subscriber unit, mobile station, remote terminal, access terminal, user terminal, terminal device, or user equipment (UE).

The apparatus 1400 comprises at least one processor 1410. The at least one processor 1410 interprets computer program instructions and processes data. The at least one processor 1410 may comprise one or more programmable processors. The at least one processor 1410 may comprise programmable hardware with embedded firmware and may, alternatively or additionally, comprise one or more application-specific integrated circuits (ASICs).

The at least one processor 1410 is coupled to at least one memory 1420. The at least one processor is configured to read and write data to and from the at least one memory 1420. The at least one memory 1420 may comprise one or more memory units. The memory units may be volatile or non-volatile. It is to be noted that in some example embodiments there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The at least one memory 1420 stores computer readable instructions that are executed by the at least one processor 1410 to perform one or more of the example embodiments described above. For example, non-volatile memory stores the computer readable instructions, and the at least one processor 1410 executes the instructions using volatile memory for temporary storage of data and/or instructions.

The computer readable instructions may have been pre-stored to the at least one memory 1420 or, alternatively or additionally, they may be received, by the apparatus, via an electromagnetic carrier signal and/or may be copied from a physical entity such as a computer program product. Execution of the computer readable instructions by the at least one processor 1410 causes the apparatus 1400 to perform one or more of the example embodiments described above. That is, the at least one processor and the at least one memory storing the instructions may provide the means for providing or causing the performance of any of the methods and/or blocks described above.

In the context of this document, a “memory” or “computer-readable media” or “computer-readable medium” may be any non-transitory media or medium or means that can contain, store, communicate, propagate or transport the instructions for use by or in connection with an instruction execution system, apparatus, or device, such as a computer. The term “non-transitory,” as used herein, is a limitation of the medium itself (i.e., tangible, not a signal) as opposed to a limitation on data storage persistency (e.g., RAM vs. ROM).

The apparatus 1400 may further comprise, or be connected to, an input unit 1430. The input unit 1430 may comprise one or more interfaces for receiving input. The one or more interfaces may comprise for example one or more temperature, motion and/or orientation sensors, one or more cameras, one or more accelerometers, one or more microphones, one or more buttons and/or one or more touch detection units. Further, the input unit 1430 may comprise an interface to which external devices may connect to.

The apparatus 1400 may also comprise an output unit 1440. The output unit may comprise or be connected to one or more displays capable of rendering visual content, such as a light emitting diode (LED) display, a liquid crystal display (LCD) and/or a liquid crystal on silicon (LCoS) display. The output unit 1440 may further comprise one or more audio outputs. The one or more audio outputs may be for example loudspeakers.

The apparatus 1400 further comprises a connectivity unit 1450. The connectivity unit 1450 enables wireless connectivity to one or more external devices. The connectivity unit 1450 comprises at least one transmitter and at least one receiver that may be integrated to the apparatus 1400 or that the apparatus 1400 may be connected to. The at least one transmitter comprises at least one transmission antenna, and the at least one receiver comprises at least one receiving antenna. The connectivity unit 1450 may comprise an integrated circuit or a set of integrated circuits that provide the wireless communication capability for the apparatus 1400. Alternatively, the wireless connectivity may be a hardwired application-specific integrated circuit (ASIC). The connectivity unit 1450 may comprise one or more components, such as: power amplifier, digital front end (DFE), analog-to-digital converter (ADC), digital-to-analog converter (DAC), frequency converter, (de)modulator, and/or encoder/decoder circuitries, controlled by the corresponding controlling units.

It is to be noted that the apparatus 1400 may further comprise various components not illustrated in FIG. 14. The various components may be hardware components and/or software components.

As used in this application, the term “circuitry” may refer to one or more or all of the following: a) hardware-only circuit implementations (such as implementations in only analog and/or digital circuitry); and b) combinations of hardware circuits and software, such as (as applicable): i) a combination of analog and/or digital hardware circuit(s) with software/firmware and ii) any portions of hardware processor(s) with software (including digital signal processor(s), software, and memory(ies) that work together to cause an apparatus, such as a mobile phone, to perform various functions); and c) hardware circuit(s) and/or processor(s), such as a microprocessor(s) or a portion of a microprocessor(s), that requires software (for example firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of example embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (for example procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The embodiments are not limited to the example embodiments described above, but may vary within the scope of the claims. Therefore, all words and expressions should be interpreted broadly, and they are intended to illustrate, not to restrict, the example embodiments.

1-17. (canceled)

18. An apparatus comprising at least one processor, and at least one memory storing instructions which, when executed by the at least one processor, cause the apparatus at least to: determine, based on an expiration of at least one time alignment timer of at least two time alignment timers, whether to flush one or more hybrid automatic repeat request (HARQ) buffers.

19. The apparatus according to claim 18, wherein a first time alignment timer of the at least two time alignment timers is associated with a first timing advance group, and a second time alignment timer of the at least two time alignment timers is associated with a second timing advance group.

20. The apparatus according to claim 19, wherein the first timing advance group corresponds to at least one of the following: a first transmission and reception point, a first cell identity, or a first control resource set pool index,
and wherein the second timing advance group corresponds to at least one of the following: a second transmission and reception point, a second cell identity, or a second control resource set pool index.

21. The apparatus according to claim 19, further being caused to:
flush the one or more HARQ buffers in response to not receiving a timing advance command or a physical downlink control channel order after the first time alignment timer expires and before the second time alignment timer expires.

22. The apparatus according to claim 19, wherein the first timing advance group and the second timing advance group are secondary timing advance groups, and wherein the one or more HARQ buffers correspond to the first timing advance group and to the second timing advance group.

23. The apparatus according to claim 19, wherein the first timing advance group and the second timing advance group are primary timing advance groups, and wherein the one or more HARQ buffers correspond to a plurality of cells.

24. The apparatus according to claim 18, wherein the determination is based on an expiration of a first time alignment timer of the at least two time alignment timers relative to an expiration of a second time alignment timer of the at least two time alignment timers.

25. The apparatus according to claim 24, further being caused to:
flush the one or more HARQ buffers in response to the second time alignment timer expiring within a pre-defined time period relative to the expiration of the first time alignment timer.

26. The apparatus according to claim 25, further being caused to:
start a third timer in response to the expiration of the first time alignment timer, wherein the third timer corresponds to the pre-defined time period, and wherein the determination is based on whether the second time alignment timer expires before the third timer expires.

27. The apparatus according to claim 24, further being caused to:
not flush the one or more HARQ buffers in response to the second time alignment timer not expiring within a pre-defined time period relative to the expiration of the first time alignment timer.

28. The apparatus according to claim 18, further being caused to:
flush the one or more HARQ buffers in response to an expiration of a first time alignment timer of the at least two time alignment timers, wherein the flushed one or more HARQ buffers are associated with at least one of the following: a first timing advance group, a first transmission and reception point, a first cell identity, or a first control resource set pool index associated with the first time alignment timer.

29. The apparatus according to claim 28, wherein a plurality of HARQ buffers of a cell are split into at least two groups, wherein the flushed one or more HARQ buffers comprise one group of the at least two groups.

30. The apparatus according to claim 29, further being caused to:
flush a second group of the at least two groups of HARQ buffers in response to an expiration of a second time alignment timer of the at least two time alignment timers, wherein the flushed second group is associated with at least one of the following: a second timing advance group, a second transmission and reception point, a second cell identity, or a second control resource set pool index associated with the second time alignment timer.

31. The apparatus according to claim 18, further being caused to:
flush the one or more HARQ buffers of one or more cells in response to an expiration of a first time alignment timer of the at least two time alignment timers, wherein the one or more cells comprise at least a cell configured with a single timing advance group, and wherein the first time alignment timer is associated with the single timing advance group.

32. The apparatus according to claim 18, wherein the apparatus comprises, or is comprised in, a user device.

33. A method comprising:
determining, based on an expiration of at least one time alignment timer of at least two time alignment timers, whether to flush one or more hybrid automatic repeat request (HARQ) buffers.

34. An apparatus comprising at least one processor, and at least one memory storing instructions which, when executed by the at least one processor, cause the apparatus at least to:
determine, based on an expiration of at least one time alignment timer of at least two time alignment timers, whether to flush one or more hybrid automatic repeat request (HARQ) buffers,
wherein a first time alignment timer of the at least two time alignment timers is associated with a first timing advance group, and a second time alignment timer of the at least two time alignment timers is associated with a second timing advance group,
and wherein, after the first time alignment timer expires, the apparatus is further caused to flush the one or more HARQ buffers if a timing advance command or a physical downlink control channel order associated with the second timing advance group is not received before the second time alignment timer expires.

35. The apparatus according to claim 34, wherein the first timing advance group corresponds to a first control resource set pool index, and wherein the second timing advance group corresponds to a second control resource set pool index.

36. The apparatus according to claim 34, wherein the first timing advance group and the second timing advance group are primary timing advance groups, and wherein the one or more HARQ buffers correspond to all serving cells configured for the apparatus.

37. The apparatus according to claim 34, wherein the first timing advance group and the second timing advance group are secondary timing advance groups, and wherein the one or more HARQ buffers correspond to cells associated with the first timing advance group and the second timing advance group.
